(19) United States
(12) Patent Application Publication
(10) Pub. No.: US 2017/0210285 A1
(43) Pub. Date: Jul. 27, 2017

(54) FLEXIBLE LED DISPLAY FOR ADAS APPLICATION

(71) Applicant: Panasonic Automotive Systems Company of America, Division of Panasonic Corporation of North America, Peachtree City, GA (US)

(72) Inventors: SACHIKO KOBAYASHI, NOVI, MI (US); DAVID LYON, HUNTINGTON WOODS, MI (US); GARY L. BRADDOCK, GROSSE POINTE, MI (US); NARAYANI MITAL, ROYAL OAK, MI (US)

(21) Appl. No.: 15/416,475

(22) Filed: Jan. 26, 2017

Related U.S. Application Data
(60) Provisional application No. 62/287,385, filed on Jan. 26, 2016.

(51) Int. Cl. B60Q 1/50

(52) U.S. Cl. CPC B60Q 1/50

(57) ABSTRACT

A vehicle includes an obstacle detector detecting presence of a pedestrian in a forward path of the vehicle and transmitting a first signal indicative of the presence. A processing device is communicatively coupled to the obstacle detector and transmits a second signal in response to receiving the first signal. A display is mounted so as to be visible to the pedestrian and is communicatively coupled to the processing device. The display responds to receiving the second signal by providing a visible indication to the pedestrian that the pedestrian's presence has been detected by the vehicle.

### CROSS-REFERENCED TO RELATED APPLICATIONS

This application claims benefit of U.S. Provisional Application No. 62/287,385 filed on Jan. 26, 2016, which the disclosure of which is hereby incorporated by reference in its entirety for all purposes.

### FIELD OF THE INVENTION

The disclosure relates to the field of autonomous vehicle systems, and, more particularly, to autonomous vehicle systems that automatically brake in response to detecting a pedestrian/object/animal in the path of the vehicle.

### BACKGROUND OF THE INVENTION

It is known for a vehicle to detect an obstacle such as a pedestrian, object or animal in the path of the vehicle and inform the driver of the obstacle through the vehicle's infotainment system, center stack or head up display (HUD). However, there is no known way to inform a pedestrian that a vehicle has detected him.

### SUMMARY

The present invention may include the use of a flexible display that is mounted/attached to the exterior of a vehicle, such as a flexible light emitting diode (LED) display that is disposed on the grille of a vehicle. Camera-based pattern recognition technology is used to detect the presence of a pedestrian/animal/object in the path of the vehicle. In response to the detection of the pedestrian/animal/object, the display presents an indication that the pedestrian/animal/object has been recognized. Thus, the pedestrian can see the display on the exterior of the vehicle and ascertain that the vehicle has detected his presence and that the vehicle may automatically brake to avoid hitting him, if necessary. In the case of an animal, the vehicle may emit audible sound to so the animal becomes aware of the approaching vehicle. The invention may be used in conjunction with advanced driver assistance systems (ADAS) and autonomous vehicles so that the pedestrian can visually confirm that the autonomous vehicle recognizes him even when the driver is not looking at the road in autonomous mode. Thus, the pedestrian knows that he can cross the street safely even though he is walking into the path of the vehicle.

The invention may provide an advanced driver assistance system (ADAS) with an exterior pedestrian/animal/object detection indicator. Thus, the pedestrian can get a confirmation from the vehicle that the vehicle has detected him before he crosses the street.

In one embodiment, the invention comprises a vehicle including an obstacle detector detecting presence of a pedestrian in a forward path of the vehicle and transmitting a first signal indicative of the presence. A processing device is communicatively coupled to the obstacle detector and transmits a second signal in response to receiving the first signal. A display is mounted so as to be visible to the pedestrian and is communicatively coupled to the processing device. The display responds to receiving the second signal by providing a visible indication to the pedestrian that the pedestrian's presence has been detected by the vehicle.

In another embodiment, the invention comprises a vehicle including an obstacle detector detecting presence of a pedestrian in a forward path of the vehicle and transmitting a signal indicative of the presence. A display is mounted so as to be visible to the pedestrian and is communicatively coupled to the obstacle detector. The display responds to receiving the signal by providing a visible indication to the pedestrian that the pedestrian's presence has been detected by the vehicle.

In yet another embodiment, the invention comprises a method of operating a motor vehicle, including detecting a presence of a pedestrian in a forward path of the vehicle. A first signal is transmitted indicative of the presence. The first signal is received at a processing device. A second signal is transmitted from the processing device in response to receiving the first signal. In response to receiving the second signal at a display device, the display device is used to provide a visible indication to the pedestrian that the pedestrian's presence has been detected by the vehicle.

The present invention has the advantage that a pedestrian may be informed that the vehicle has detected his presence and will take steps to avoid hitting him.

Another advantage is that an animal may hear an audible sound emitted by the vehicle in response to detecting the animal, and thus the animal may become aware of the approach of the vehicle and move out of the path of the vehicle to avoid being hit by the vehicle.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular flexible LED display arrangement of the present invention.

FIG. 2 is a perspective view of one embodiment of a vehicle including the flexible LED display arrangement of FIG. 1.

FIG. 3 is a flow chart of one embodiment of a method of the present invention for operating a motor vehicle.

### DETAILED DESCRIPTION OF THE PREFERRED EMBODIMENTS

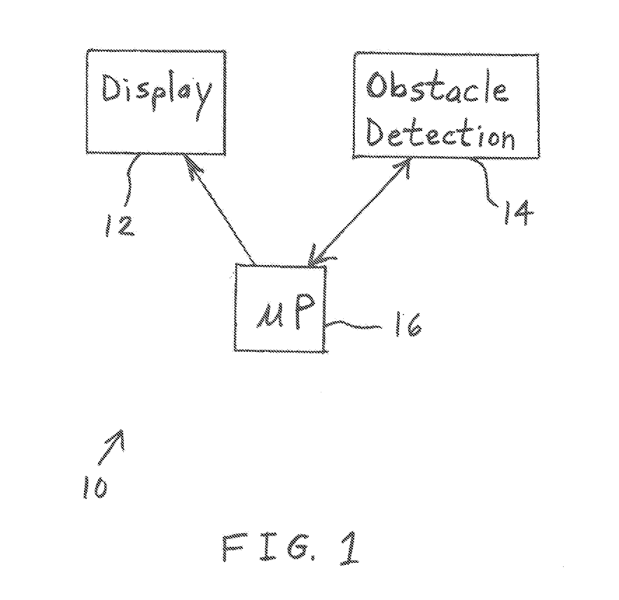

FIG. 1 illustrates one embodiment of a vehicular flexible LED display arrangement 10 of the present invention including a flexible LED display 12, an obstacle detection module 14, and an electronic processor 16. Flexible LED display 12 may be mounted on a grille on a front of a vehicle, or on some other part of the vehicle such that display 12 is visible to a pedestrian who is in front of the vehicle.

Obstacle detection module 14 may be radar-based or may employ some other technology (e.g., a camera coupled with image recognition processing) by which it is possible to detect a pedestrian, animal or object that is in the path of the vehicle in the direction in which the vehicle is heading.

Processor 16 is communicatively coupled to each of flexible LED display 12, and obstacle detection module 14. During use, when obstacle detection module 14 detects the presence of a pedestrian, animal or object that is in the forward path of the vehicle, module 14 transmits a signal to processor 16. In response to receiving the signal from module 14, processor 16 transmits a signal to display 12 which causes display 12 to present a visible indication that the presence of the pedestrian, animal or object has been detected. For example, the LEDs of display 12 may be lit. In the event that the pedestrian, animal or object is a pedestrian, the pedestrian may see the visible indication and know that the vehicle has detected his presence and is likely to automatically stop or brake before the vehicle runs into the pedestrian. For example, if a vehicle is approaching a stop light at a moderate speed and the pedestrian wants to cross the street at the stop light, he may ascertain from the presentation on display 12 that he may safely begin walking into the cross walk even though the vehicle needs further braking in order to avoid running into the pedestrian.

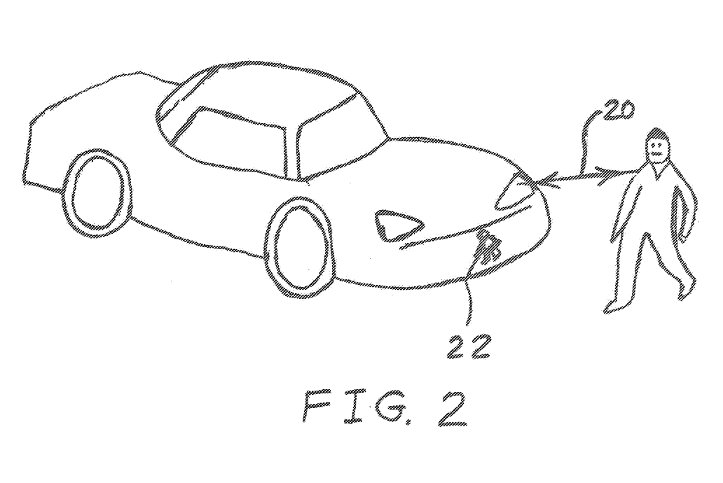

FIG. 2 illustrates one embodiment of a vehicle including a vehicular flexible LED display arrangement of the present invention. An obstacle detection module is disposed near the vehicle's left headlight, and emits radar energy which is reflected by a pedestrian back to the obstacle detection module, as indicated by double arrow 20. The obstacle detection module may collect enough data to detect not just the presence of the pedestrian, but also an outline and/or size of the pedestrian. A flexible LED display is mounted on the front grille, and selected LEDs of the display are lit in order to present an outline or other image of the pedestrian, as indicated at 22. The pedestrian can see the outline or image of himself on the grille. The display may also show only an icon or text informing the pedestrian that the vehicle has detected him/her.

The invention has been described herein as providing the flexible display on the front grille. However, it is also possible within the scope of the invention to apply or mount the flexible display to a part of the vehicle other than the grille, such as on a front facing surface of a rear view mirror, or on a hood of the vehicle.

As the invention has been described herein, the processing device receives the first signal from the obstacle detector and transmits a second signal to the display in response thereto. However, in another embodiment, the processor is eliminated, and the obstacle detector sends a signal directly to the display in order to cause the display to present an indication that the obstacle detector has detected an obstacle.

The invention has been described herein as providing a display on a grille of a vehicle to inform a pedestrian that the vehicle has detected his presence. However, it is also possible to provide the display anywhere on the vehicle. For example, the display may be mounted on the rear of the vehicle and may show or indicate detection of an object or a person behind the vehicle. It is further possible to provide an audible warning to inform a pedestrian that the vehicle has detected his presence, or to get the attention of an animal and make him aware that the vehicle is approaching. For example, the vehicle may include an audio sound emitter that is activated in response to receiving a third signal from the processing device. In an embodiment in which the processing device is eliminated, the audio sound emitter is activated in response to receiving a signal directly from the obstacle detector.

Although the invention may be very useful for autonomous vehicles, it can also be advantageously used with driver-controlled vehicles to give additional confidence to the pedestrian that driver sees him.

In one embodiment, a driver monitoring system, which may include a camera inside the vehicle, may perform face tracking and/or eye gaze tracking in order to determine in which direction the driver is looking. This face tracking and/or eye gaze tracking may be used instead of or in addition to the exterior sensor to ascertain whether the presence of a pedestrian has been noticed within the vehicle.

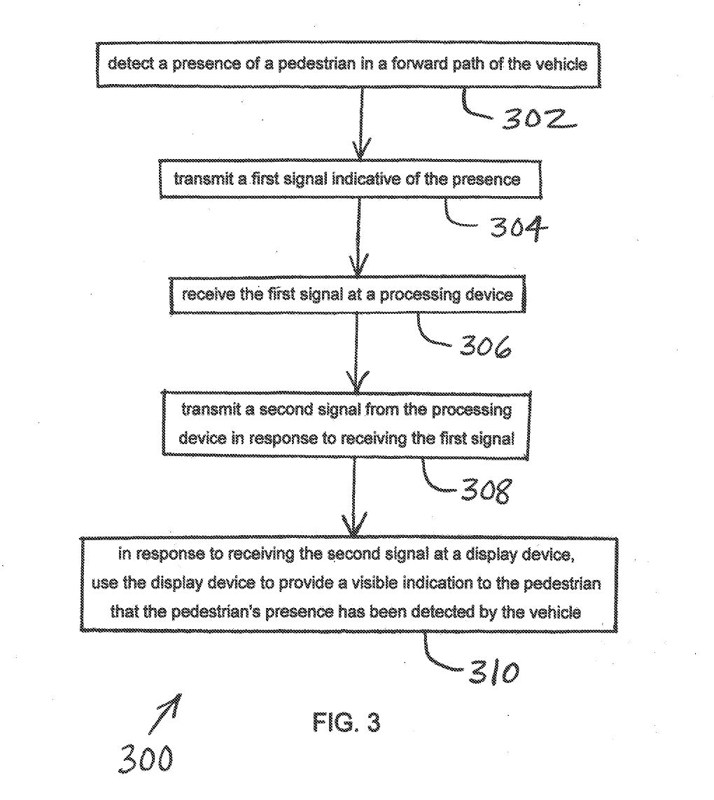

One embodiment of a method 300 of the present invention for operating a motor vehicle is illustrated in FIG. 3. In a first step 302, a presence of a pedestrian in a forward path of the vehicle is detected. For example, a radar-based obstacle detection module 14 may detect a pedestrian in the path of the vehicle in the direction in which the vehicle is heading.

In a next step 304, a first signal indicative of the presence is transmitted. For example, when obstacle detection module 14 detects the presence of a pedestrian that is in the forward path of the vehicle, module 14 transmits a signal to processor 16.

In step 306, the first signal is received at a processing device. That is, processor 16 may receive the signal transmitted by obstacle detection module 14.

Next, in step 308, a second signal is transmitted from the processing device in response to receiving the first signal. For example, in response to receiving the signal from module 14, processor 16 may transmit a signal to display 12.

In a final step 310, in response to receiving the second signal at a display device, the display device is used to provide a visible indication to the pedestrian that the pedestrian's presence has been detected by the vehicle. For example, the signal to display 12 may cause display 12 to present a visible indication that the presence of the pedestrian has been detected. For example, the LEDs of display 12 may be lit.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
an obstacle detector configured to detect presence of a pedestrian in a forward path of the vehicle and transmit a first signal indicative of the presence;
a processing device communicatively coupled to the obstacle detector and configured to transmit a second signal in response to receiving the first signal; and
a display mounted so as to be visible to the pedestrian and communicatively coupled to the processing device, the display being configured to respond to receiving the second signal by providing a visible indication to the pedestrian that the pedestrian's presence has been detected by the vehicle.

2. The vehicle of claim 1 wherein the obstacle detector is radar-based.

3. The vehicle of claim 1 wherein the display comprises a flexible light emitting diode display.

4. The vehicle of claim 1 wherein the display is mounted on a front grille of the vehicle.

5. The vehicle of claim 1 wherein the obstacle detector detects an outline of the pedestrian, and the display provides an image of the outline of the pedestrian such that the image of the outline is visible to the pedestrian.

6. The vehicle of claim 1 wherein the obstacle detector is disposed adjacent to a headlight of the vehicle.

7. The vehicle of claim 1 wherein the processing device is configured to transmit a third signal in response to receiving the first signal, the vehicle further comprising an audio sound emitter configured to be activated in response to receiving the third signal from the processing device.

8. A vehicle, comprising:
an obstacle detector configured to detect presence of a pedestrian in a forward path of the vehicle and transmit a signal indicative of the presence; and
a display mounted so as to be visible to the pedestrian and communicatively coupled to the obstacle detector, the display being configured to respond to receiving the signal by providing a visible indication to the pedestrian that the pedestrian's presence has been detected by the vehicle.

9. The vehicle of claim 8 wherein the obstacle detector is radar-based.

10. The vehicle of claim 8 wherein the display comprises a flexible light emitting diode display.

11. The vehicle of claim 8 wherein the display is mounted on a front grille of the vehicle.

12. The vehicle of claim 8 wherein the obstacle detector detects an outline of the pedestrian, and the display provides an image of the outline of the pedestrian such that the image of the outline is visible to the pedestrian.

13. The vehicle of claim 8 wherein the obstacle detector is disposed adjacent to a headlight of the vehicle.

14. The vehicle of claim 8 further comprising an audio sound emitter configured to be activated in response to receiving a signal from the obstacle detector.

15. A method of operating a motor vehicle, said method comprising:
detecting a presence of a pedestrian in a forward path of the vehicle;
transmitting a first signal indicative of the presence;
receiving the first signal at a processing device;
transmitting a second signal from the processing device in response to receiving the first signal; and
in response to receiving the second signal at a display device, using the display device to provide a visible indication to the pedestrian that the pedestrian's presence has been detected by the vehicle.

16. The method of claim 15 wherein the obstacle detector is radar-based, and the display device comprises a flexible light emitting diode display device.

17. The method of claim 15 further comprising mounting the display device on a front grille of the vehicle.

18. The method of claim 15 wherein the obstacle detector detects an outline of the pedestrian, and the display device provides an image of the outline of the pedestrian such that the image of the outline is visible to the pedestrian.

19. The method of claim 15 wherein the obstacle detector is disposed adjacent to a headlight of the vehicle.

20. The method of claim 15 further comprising:
transmitting a third signal from the processing device in response to receiving the first signal; and
in response to receiving the third signal, emitting an audible sound such that the audible sound may be heard by the pedestrian.
